(19) United States
(12) Patent Application Publication
(10) Pub. No.: US 2026/0011749 A1
(43) Pub. Date: Jan. 8, 2026

(54) ELECTRODE ASSEMBLY AND MANUFACTURING METHOD THEREOF

(71) Applicant: SAMSUNG SDI CO., LTD., Yongin-Si (KR)

(72) Inventor: Kyunggeun KIM, Yongin-Si (KR)

(21) Appl. No.: 19/087,180

(22) Filed: Mar. 21, 2025

(30) Foreign Application Priority Data
Jul. 5, 2024 (KR) 10-2024-0088775

(51) Int. Cl. H01M 4/70; H01M 4/04; H01M 10/0587

(52) U.S. Cl. CPC H01M 4/70; H01M 4/0404; H01M 4/0435; H01M 10/0587

(57) ABSTRACT

An electrode assembly includes a first electrode plate including a first substrate, the first substrate including a first mixture layer thereon, a second electrode plate including a second substrate, the second substrate including a second mixture layer thereon, and a separator between the first electrode plate and the second electrode plate, wherein the first electrode plate, the separator, and the second electrode plate are wound to form a flat portion and a curved portion, and a pattern area is on the curved portion of the first electrode plate or the curved portion of the second electrode plate.

### CROSS-REFERENCE TO RELATED APPLICATION

The present application claims priority to and the benefit of Korean Patent Application No. 10-2024-0088775, filed on Jul. 5, 2024, in the Korean Intellectual Property Office, the entire disclosure of which is incorporated herein by reference.

### BACKGROUND

### 1. Field

Embodiments of the present disclosure described herein are related to an electrode assembly and a method of manufacturing the electrode assembly. For example, embodiments of the present disclosure described herein are related to an electrode assembly having a pattern area and a method of manufacturing the electrode assembly.

### 2. Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An electrode assembly may be formed by winding or stacking a stack of a first electrode plate, a separator, and a second electrode plate, which are formed as thin plates or films. A wound electrode assembly may include a curved portion having a curvature as a result of winding and a flat portion which is stacked to be flat.

Excessive or greater stress occurs in the curved portion more than in the flat portion during the winding process of the wound electrode assembly and the charging and discharging process of the secondary battery, causing lithium ions passing through the separator to be precipitated as lithium metal. In addition, in a unit cell in which a positive electrode plate, a separator, and a negative electrode plate are stacked, a capacity ratio (an N/P ratio or a facing ratio) of the facing areas of the positive electrode and the negative electrode facing each other with the separator therebetween is decreased, reversed, or increased. These may be causes of performance degradation, including reduced long-life characteristics of secondary batteries. To solve these problems, a method to alleviate stress in the curved portion during the secondary battery manufacturing process may be desirable.

The above information disclosed in this Background section is for enhancement of understanding of the background of the present disclosure, and therefore, it may contain information that does not constitute related (or prior) art.

### SUMMARY

To solve the problems described above, aspects according to one or more aspects of embodiments are directed toward an electrode assembly and a method of manufacturing the electrode assembly.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to some embodiments of the present disclosure, an electrode assembly includes a first electrode plate including a first substrate, the first substrate including a first mixture layer thereon, a second electrode plate including a second substrate, the second substrate including a second mixture layer thereon, and a separator between the first electrode plate and the second electrode plate, wherein the first electrode plate, the separator, and the second electrode plate are wound to form a flat portion and a curved portion, and a pattern area is on the curved portion of the first electrode plate or the curved portion of the second electrode plate.

According to some embodiments, the pattern area may include a substrate pattern in the first substrate or the second substrate.

According to some embodiments, the substrate pattern may include grooves.

According to some embodiments, the grooves may have a stripe shape.

According to some embodiments, an extension direction of the groove having the stripe shape may be perpendicular to a longitudinal direction of the first electrode plate or the second electrode plate.

According to some embodiments, the grooves may be on an inner surface of the first substrate or on an inner surface of the second substrate.

According to some embodiments, the substrate pattern may include holes.

According to some embodiments, each of the holes may have a diameter of several tens of micrometers.

According to some embodiments, the holes may be arranged to form columns.

According to some embodiments, the holes may be formed by punching or etching.

According to some embodiments, a mixture included in the first mixture layer or in the second mixture layer is configured to pass through the first substrate or the second substrate through the holes.

According to some embodiments, the pattern area may include a mixture pattern in the first mixture layer or in the second mixture layer.

According to some embodiments, the mixture pattern may be in the first mixture layer on an inner surface of the first substrate or is in the second mixture layer on an inner surface of the second substrate.

According to some embodiments, the mixture pattern may be in a mixture layer on an inner surface of an electrode plate arranged at an innermost surface of the electrode assembly.

According to some embodiments, the mixture pattern may include grooves.

According to some embodiments, the grooves may be formed by a laser.

According to some embodiments, the grooves may have a stripe shape.

According to some embodiments, an extension direction of the groove having the stripe shape may be perpendicular to a longitudinal direction of the first electrode plate or the second electrode plate.

According to some embodiments of the present disclosure, a method for manufacturing an electrode assembly includes determining a processing site to be a curved portion in an electrode substrate, forming holes or grooves at the processing site to be the curved portion in the electrode substrate, applying an electrode mixture to the electrode substrate in which the holes or grooves are formed, and rolling the electrode substrate to which the electrode mixture is applied.

According to some embodiments of the present disclosure, a method for manufacturing an electrode assembly includes determining a processing site to be a curved portion in an electrode substrate, applying an electrode mixture to the electrode substrate, forming grooves in an electrode mixture portion corresponding to the processing site to be the curved portion in the electrode substrate, and rolling the electrode substrate to which the electrode mixture is applied.

According to some embodiments of the present disclosure, the density of the electrode mixture may be locally controlled by forming a plurality of grooves through laser processing in the mixture layer of the electrode plate constituting the electrode assembly or by forming holes through punching or etching in the substrate of the electrode plate.

According to some embodiments of the present disclosure, by processing (e.g., selectively processing) the substrate or the mixture layer in the curved portions formed at opposite ends of the flat portion of the wound electrode assembly, stress due to swelling of the electrode plate in the curved portion is relieved or reduced, long-life characteristics of the battery are improved, and lithium metal precipitation on the surface of the negative electrode is reduced, thereby minimizing or reducing the defect rate of the batteries and improving charge/discharge performance.

According to some embodiments of the present disclosure, ions may pass (e.g., smoothly pass) through holes formed in the electrode plate substrate of the wound electrode assembly, and the bonding force between the mixture layer of the electrode plate and the substrate may be increased.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view showing a pouch-type secondary battery.

FIG. 2 illustrates a schematic diagram for schematically describing the cross-section of the wound electrode assembly.

FIG. 3 illustrates the substrate pattern according to one or more embodiments of the present disclosure.

FIG. 4 illustrates the substrate pattern according to one or more embodiments of the present disclosure.

FIG. 5 illustrates a diagram for schematically describing a process in which a mixture passes through a substrate through a plurality of holes.

The left side of FIG. 6 illustrates an enlarged view of the cross-section of the curved portion of the electrode assembly without a substrate pattern, and the right side of FIG. 6 illustrates an enlarged view of the cross-section of the curved portion of the electrode assembly with a substrate pattern.

FIG. 7 illustrates an electrode plate including a mixture pattern according to one or more embodiments of the present disclosure.

The left side of FIG. 8 illustrates an enlarged view of the cross-section of the curved portion of the electrode assembly without a mixture pattern, and the right side of FIG. 8 illustrates an enlarged view of the cross-section of the curved portion of the electrode assembly with a mixture pattern.

The left side of FIG. 9 is an enlarged view of the cross-section of the curved portion of the electrode assembly without a mixture pattern, and the right side of FIG. 9 is an enlarged view of the cross-section of the curved portion of the electrode assembly with a mixture pattern. The area where the mixture pattern is formed is indicated by a dashed box.

FIG. 10 illustrates the process of processing the pattern on the curved portion of an electrode plate before winding.

FIG. 11 illustrates a flowchart showing a method for manufacturing an electrode assembly according to one or more embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

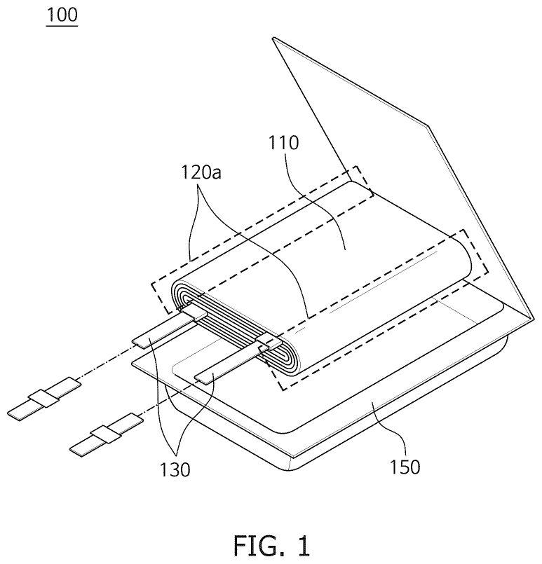

FIG. 1 illustrates a perspective view showing a pouch-type secondary battery.

As illustrated in FIG. 1, a pouch-type secondary battery 100 may include an electrode assembly 110, an electrode lead extending from an electrode tab 130 of the electrode assembly 110, a lower case 150 covering the lower surfaces of the electrode assembly and the electrode lead, and an upper case 150 sealed with the lower case 150.

The electrode assembly 110 may be formed by winding or stacking a stack of a first electrode plate, a separator, and a second electrode plate formed in a thin plate shape or a film shape. In a case where the electrode assembly 110 is a wound stack, the winding axis may be parallel to the longitudinal direction of the case.

For example, in a case where the first electrode plate is a negative electrode plate, the first electrode plate may be formed by applying a first mixture layer, such as graphite or carbon, to a first substrate including (e.g., formed of) a metal foil such as copper, a copper alloy, nickel, or a nickel alloy. A first uncoated portion may be formed in an area where the first mixture layer is not applied. For example, the first uncoated portion may include an area of the first substrate that does not include the first mixture layer. The electrode tab 130 may be joined to the first uncoated portion. The electrode tab 130 may serve as a passage for a current flow between the first electrode plate and the first current collector. In some examples, the electrode tab 130 may be formed by cutting to protrude toward one side in advance in a case of manufacturing the first electrode plate, and may further protrude toward one side than the separator without separate cutting.

For example, in a case where the second electrode plate is a positive electrode plate, the second electrode plate may be formed by applying a second mixture layer, such as a transition metal oxide, to a second substrate including (e.g., formed of) a metal foil such as aluminum or an aluminum alloy. A second uncoated portion may be formed in an area where the second mixture layer is not applied. For example, the second uncoated portion may include an area of the second substrate that does not include the second mixture layer. The electrode tab 130 may be joined to the second uncoated portion. The electrode tab 130 may serve as a passage for a current flow between the second electrode plate and the second current collector. In some examples, the electrode tab 130 may be formed by cutting to protrude toward the other side in advance in a case of manufacturing the second electrode plate, and may further protrude toward the other side than the separator without separate cutting.

Although a case where the first electrode plate is a negative electrode plate and the second electrode plate is a positive electrode plate has been described above, the present disclosure is not limited thereto. The first electrode plate may correspond to a negative electrode plate or a positive electrode plate, and the second electrode plate may correspond to the remaining electrode plate. For example, in a case where the first electrode plate is a negative electrode plate, the second electrode plate may be a positive electrode plate. In some embodiments, in a case where the first electrode plate is a positive electrode plate, the second electrode plate may be a negative electrode plate.

The electrode tab 130 of the first electrode plate and the electrode tab 130 of the second electrode plate are respectively located at opposite ends or at one end of the electrode assembly 110. In some examples, the electrode assembly 110 may be accommodated in the case 150 together with an electrolyte.

The secondary battery 100 including the electrode assembly 110 according to one or more embodiments of the present disclosure is not limited thereto, and the case may be configured in one or more suitable shapes, for example, a circular shape, a prismatic shape, and a pouch shape. In some embodiments, the case may include (e.g., may be composed of) metal such as aluminum, an aluminum alloy, or nickel-plated steel, or a laminated film or plastic that constitutes a pouch. For example, it may be any type of secondary battery including the wound electrode assembly 110 according to one or more embodiments.

As illustrated in FIG. 1, the electrode assembly 110 according to one or more embodiments may include a first electrode plate having a first substrate, on which a first mixture layer is formed on, a second electrode plate having a second substrate, on which a second mixture layer is formed on, and a separator interposed between the first electrode plate and the second electrode plate. For example, the electrode assembly 110 may include a first electrode plate, a second electrode plate, and a separator between the first electrode plate and the second electrode plate. The first electrode plate may include a first substrate including a first mixture layer on the first substrate. The second electrode plate may include a second substrate including a second mixture layer on the second substrate. The first electrode plate, the separator, and the second electrode plate may be wound to form a flat portion and a curved portion 120a. The curved portion 120a may refer to a portion having a curvature in the mixture layer and/or the substrate of the rolled electrode assembly 110.

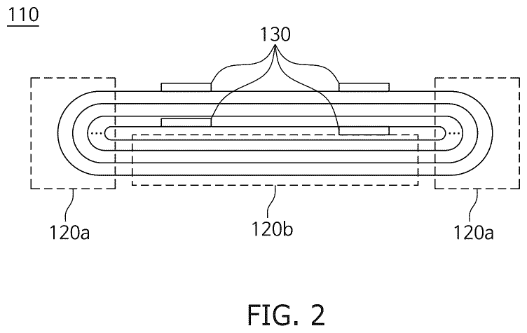

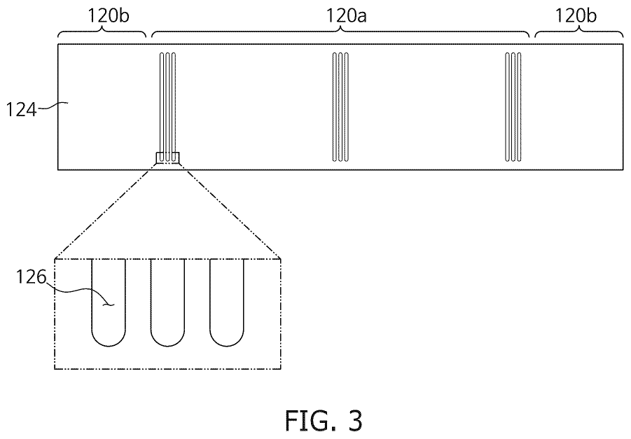

FIG. 2 illustrates a schematic diagram for schematically describing the cross-section of the wound electrode assembly.

Referring to FIG. 2, the curved portion 120a of the wound electrode assembly 110 according to one or more embodiments of the present disclosure may be formed at opposite ends of the flat portion 120b, and the electrode tab 130 may be formed on the flat portion 120b. The number of electrode tabs 130 that may be connected to or become part of the electrode plate may be one or more per electrode.

During the winding process of the electrode assembly 110, stress may occur in the electrode assembly 110. In addition, during the use of the secondary battery 100, stress due to expansion and contraction of the electrode mixture layer may occur in the electrode assembly 110 in a case where charging and discharging are repeated. Even in a case where the same amount of pressure is applied to the electrode assembly 110, stress concentration may occur in the curved portion 120a. When charging and discharging the secondary battery 100, lithium metal is precipitated in an area where stress concentration occurs, which deteriorates or reduces the charging and discharging performance, and may cause battery failure due to a short circuit caused by the detachment of lithium metal. In order to solve this problem, according to one or more embodiments of the present disclosure, a pattern area may be formed on the first electrode plate or the second electrode plate belonging to the curved portion 120a. The pattern area according to one or more embodiments may include a substrate pattern formed on the substrate and a mixture pattern formed on the mixture layer.

FIG. 3 illustrates the substrate pattern according to one or more embodiments of the present disclosure. FIG. 3 illustrates a portion of a substrate 124 unfolded on a plane. The substrate 124 may correspond to a substrate of a positive electrode plate or a negative electrode plate. For example, the substrate 124 may correspond to a first substrate of the first electrode plate or a second substrate of the second electrode plate.

The substrate 124 may include a curved portion 120a and a flat portion 120b. A pattern may be formed in the curved portion 120a of the substrate. The substrate pattern may include a plurality of grooves 126, as illustrated in FIG. 3. The groove 126 is a structure that does not pass through the substrate 124 and may be recessed from the substrate 124 and formed as a negative engraving. The grooves 126 may be formed in stripe shape (e.g., stripe-shaped groove). That is, the grooves 126 may have a stripe shape. The stripe-shaped groove 126 may be extended in the longitudinal direction of the substrate 124 or in the direction perpendicular to the longitudinal direction of the electrode plate. The longitudinal direction may refer to the long side direction in a case where the electrode plate is unfolded.

In the wound electrode assembly 110 according to one or more embodiments of the present disclosure, the first electrode plate may be a negative electrode plate and the second electrode plate may be a positive electrode plate. In a case where the opposing area of the first electrode plate is larger than the opposing area of the second electrode plate, an N/P ratio higher than the design may be obtained. In addition, because the inner surface of the substrate 124 belonging to the curved portion 120a has a greater change in curvature than the outer surface of the substrate 124 belonging to the same curved portion 120a, greater stress may occur on the inner surface of the substrate 124. In order to solve these problems together, the grooves 126 may be formed on the inner surface of the first substrate of the first electrode plate having a relatively large opposing area, and accordingly, the first mixture layer may be applied to the inner surface of the first substrate, thereby forming a local low-density area. As a result, the N/P ratio may be reduced along with the relieved stress in the curved portion.

In order to improve the balance of the N/P ratio, the substrate pattern that includes (e.g., optionally includes) the grooves 126 may be formed on the inner or outer surface of the substrate 124. However, in a case where the substrate pattern is formed on the outer surface of the substrate 124, the substrate pattern may be formed on the inner surface of the outer adjacent substrate 124 facing the corresponding substrate. Accordingly, the N/P ratio may be stabilized.

In one or more embodiments, the imbalance problem where the N/P ratio deviates from the design value may be greater in the curved portion of the electrode plate located at the innermost surface (e.g., the innermost surface of the jelly roll) where the difference in the radius of curvature between the opposing inner and outer electrode plates is the largest. Accordingly, in a case where the grooves 126 are formed on the inner surface of the substrate 124 arranged at the innermost side, the degree of stabilization of the N/P ratio may be the greatest.

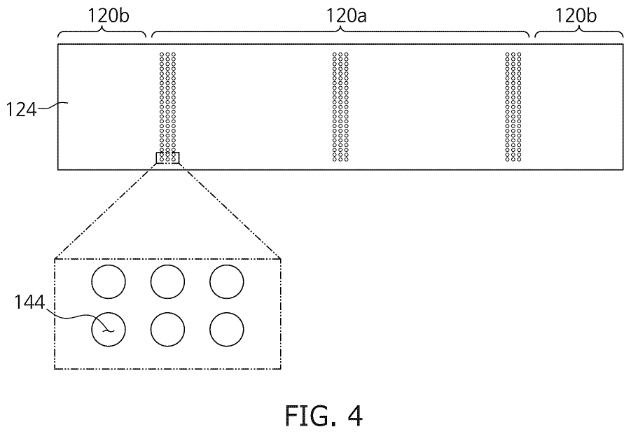

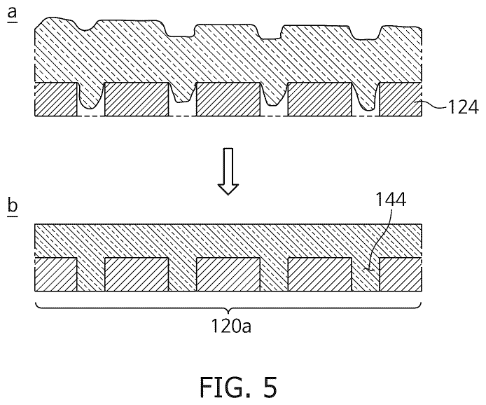

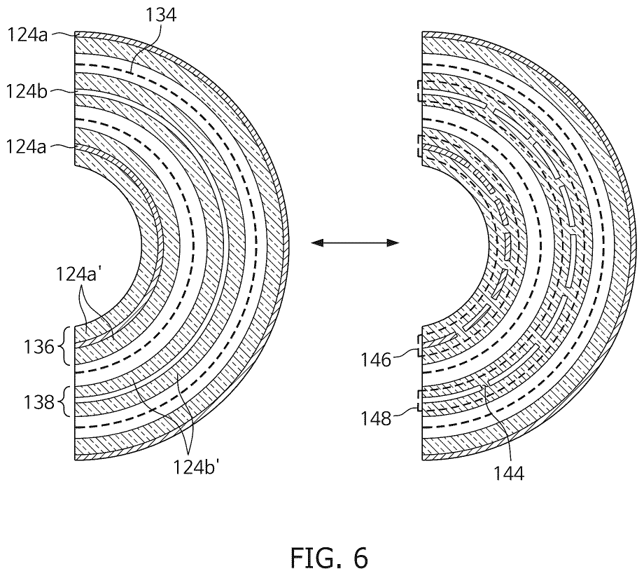

FIG. 4 illustrates the substrate pattern according to one or more embodiments of the present disclosure. FIG. 5 illustrates a portion of a substrate 124 unfolded on a plane. The substrate 124 may correspond to a substrate of a positive electrode plate or a negative electrode plate. For example, the substrate 124 may correspond to a first substrate of the first electrode plate or a second substrate of the second electrode plate. Regarding FIG. 4, the description will focus on differences from the configuration illustrated in FIG. 3.

As another example, as illustrated in FIG. 4, the substrate pattern may include a plurality of holes 144. The holes 144 may pass through the substrate 124. Each of the holes 144 may be formed to have a size of several tens of micrometers. For example, the diameter of each of the holes 144 may be 20 μm, and the spacing between the holes 144 may be 100 μm. The holes 144 may be arranged to form a plurality of rows, and there is no limitation on the number of columns or the pattern of columns. The holes 144 may be formed by a chemical method and/or a mechanical method depending on the metal material and thickness of the substrate 124, and for example, may be formed through punching or etching. The columns may be arranged in a direction perpendicular to the length direction of the substrate or the length direction of the electrode plate.

FIG. 5 illustrates a diagram for schematically describing a process in which a mixture passes through a substrate through a plurality of holes. FIG. 5 illustrates the cross-section of the electrode plate belonging to the curved portion 120a.

Referring to FIG. 5, after the mixture included in the first mixture layer or the second mixture layer is applied to the first substrate or the second substrate, the mixture of the first mixture layer or the mixture of the second mixture layer may enter the holes 144 (process a). In the process in which the mixture enters the holes 144, a change in thickness of a mixture layer 122 may occur locally. For example, with respect to the upper surface of the substrate 124, the thickness of the mixture layer 122 at a position corresponding to the hole 144 may be different from the thickness of the mixture layer 122 at a position not corresponding to the hole.

Thereafter, while passing through the rolling process, the mixture may pass through the substrate 124 in the depth direction of the holes 144 (process b). In this process, the thickness of the mixture layer 122 may be reduced as a whole with respect to the upper surface of the substrate 124. Accordingly, in the electrode plate area where the holes 144 are formed, a low-density area with a lower density of the mixture than the existing design density area may be formed. In one or more embodiments, in the electrode plate area where the holes 144 are not formed, a normal density area corresponding to the existing design density area may be formed.

The mixture may be applied not only to one side of the electrode plate as illustrated in FIG. 5, but also to the other side (e.g., opposite side) of the electrode plate. Therefore, ion permeability may be increased by securing additional electrolyte transport paths on opposite sides. In addition, the side reactions of the negative electrode may be suppressed or reduced, thereby improving the long-life characteristics and high-rate characteristics of the battery. By directly connecting the mixtures formed on opposite sides of the electrode plate to each other, the bonding strength between the substrate 124 and the mixture may be improved. In addition, the mechanical rigidity of the electrode assembly 110 may be increased and the high-rate characteristics may be improved.

The left side of FIG. 6 illustrates an enlarged view of the cross-section of the curved portion of the electrode assembly without a substrate pattern, and the right side of FIG. 6 illustrates an enlarged view of the cross-section of the curved portion of the electrode assembly with a substrate pattern. The area where the substrate pattern is formed is indicated by a dashed box.

A wound electrode assembly 110 may be formed by winding a plurality of unit cells in which a first electrode plate 136, a separator 134, and a second electrode plate 138 are stacked. In addition, the outermost electrode plate of the electrode assembly 110 may be manufactured to be finished with a first substrate 124a or a second substrate 124b.

Referring to FIG. 6, in the electrode assembly 110 according to one or more embodiments of the present disclosure, the first electrode plate 136 may be a negative electrode plate and the second electrode plate 138 may be a positive electrode plate. For example, the first electrode substrate pattern may correspond to a negative electrode substrate pattern 146 and the second electrode substrate pattern may correspond to a positive electrode substrate pattern 148. For example, the electrode assembly 110 may include an inner negative electrode substrate pattern 146 and an outer positive electrode substrate pattern 148 opposite thereto, and each substrate pattern may include a plurality of holes 144.

In this case, a low-density area may be formed in which a density of the mixture is lower than the design density by the holes 144 with respect to the positive electrode substrate on the outer surface and the negative electrode substrate on the inner surface, which are arranged with the separator 134 therebetween. However, because the opposing area of the opposing positive electrode plates is larger than the opposing area of the negative electrode plates, the holes 144 may be processed so that the capacity reduction rate of the positive electrode substrate is larger than the capacity reduction rate of the negative electrode substrate. This may increase the reduced N/P ratio. In addition, ions that may pass through the porous separator 134 may freely pass through the holes of the positive electrode substrate and the holes of the negative electrode substrate.

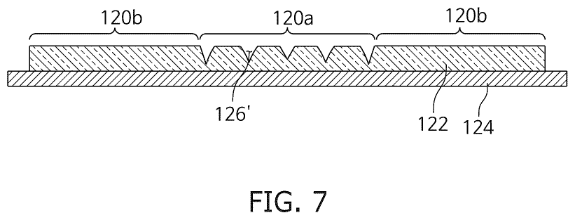

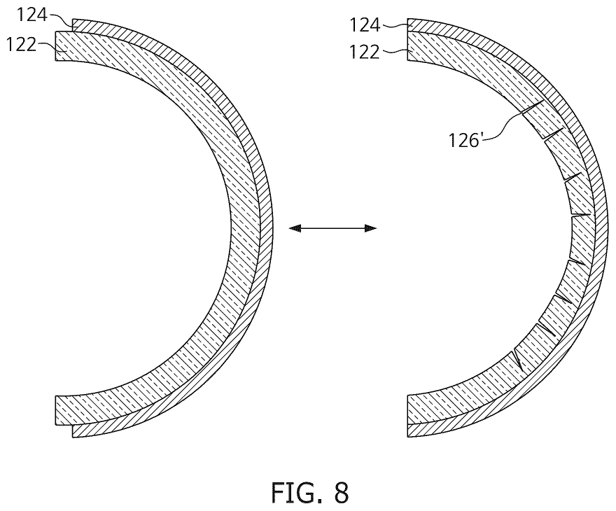

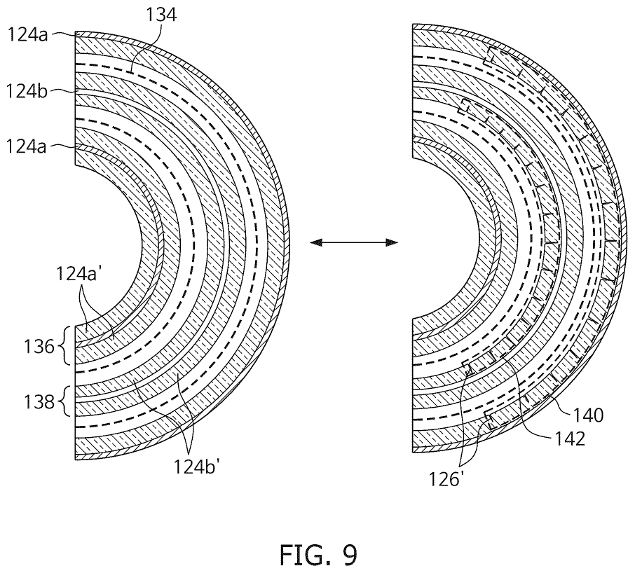

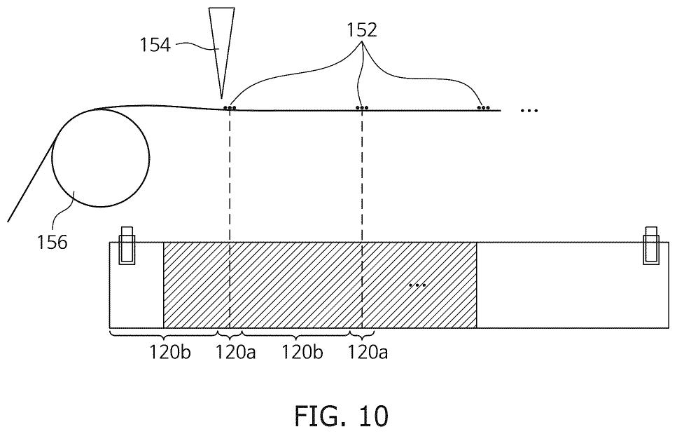

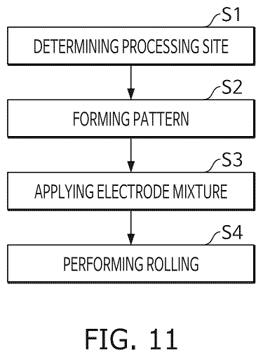

FIG. 7 illustrates an electrode plate including a mixture pattern according to one or more embodiments of the present disclosure. FIG. 7 illustrates the cross-section of the electrode plate belonging to the curved portion 120a.

The mixture pattern may be formed on a mixture layer 122 formed on a substrate 124 of the electrode plate. The mixture pattern may include a plurality of grooves 126′. The grooves 126′ may be formed through laser processing. The width and depth of the groove 126′ to be processed may be adjusted depending on the laser output and the material of the mixture layer 122. In addition, there is no limitation on the shape of each of the grooves 126′. For example, the grooves 126′ may be formed in a stripe shape (e.g., striped-shaped grooves), and the extension direction of the stripe shape may be perpendicular to the length direction of the electrode plate. That is, the grooves 126′ may have a stripe shape. The longitudinal direction may refer to the long side direction in a case where the electrode plate is unfolded.

In addition, the stripe shape may be formed in a long stripe shape, so that each short stripe forms a plurality of rows and columns. In addition, a plurality of stripe groups may form a pattern (e.g., constant pattern). The pattern may be adjusted according to the convenience of the process. In one or more embodiments, the shape of each of the grooves 126′ may be circular or oval. Similarly, there is no limitation on the arrangement of the grooves 126′. For example, the grooves 126′ may have one or more suitable shapes.

Referring to FIG. 7, a mixture pattern in which the grooves 126′ are formed may be formed in the mixture layer 122 of the area belonging to the curved portion 120a of the electrode plate before being wound. For example, grooves 126′ may be formed in the mixture layer 122 in the curved portion 120a of the electrode plate before the electrode plate is wound. A pattern may not be formed in the mixture layer 122 in the area belonging to the flat portion 120b. For example, the mixture layer 122 in the flat portion 120b may not include the mixture pattern. Accordingly, the area where the mixture pattern is formed may be a low-density area with a low mixture density, and the area where the mixture pattern is not formed may be a design density area or a normal density area. For example, the low-density area may be an area including the mixture pattern with a low mixture density. The design density area or the normal density area may be an area that does not include the mixture pattern. In addition, the mixture pattern may be formed (e.g., selectively formed) only at a position of the curved portion 120a where stress is concentrated.

The left side of FIG. 8 illustrates an enlarged view of the cross-section of the curved portion of the electrode assembly without a mixture pattern, and the right side of FIG. 8 illustrates an enlarged view of the cross-section of the curved portion of the electrode assembly with a mixture pattern.

As illustrated in FIG. 8, the mixture pattern may be formed on the mixture layer 122. For example, the mixture pattern may be formed on the mixture layer 122 formed on the inner surface of the substrate 124. That is, the mixture pattern may be on the mixture layer 122 and the mixture layer 122 may be on the inner surface of the substrate 124. The mixture pattern may include a plurality of grooves 126′. In one or more embodiments, each of the grooves 126′ may be formed in the direction of the center of curvature in the structure in which the electrode plate is wound. In some embodiments, each of the grooves 126′ may be formed so that the grooves 126′ are perpendicular to the substrate 124 on the electrode plate before being wound. However, the present disclosure is not limited thereto, and the direction of the grooves 126′ may be in one or more suitable directions.

The left side of FIG. 9 is an enlarged view of the cross-section of the curved portion of the electrode assembly without a mixture pattern, and the right side of FIG. 9 is an enlarged view of the cross-section of the curved portion of the electrode assembly with a mixture pattern. The area where the mixture pattern is formed is indicated by a dashed box.

According to one or more embodiments of the present disclosure, in the wound electrode assembly 110, a first mixture layer 124a′ may be a negative electrode mixture layer, and a second mixture layer 124b′ may be a positive electrode mixture layer. In this case, as illustrated in FIG. 9, a negative electrode mixture pattern 140 may be formed on the inner surface of the negative electrode substrate, and a positive electrode mixture pattern 142 may be formed on the inner surface of the positive electrode substrate. Each mixture pattern may include the grooves 126′ according to one or more embodiments as described above.

In a case where the negative plate is formed on the inner side and the opposing positive plate is formed on the outer side, the N/P ratio of the curved portion 120a may be locally smaller than the design. This may cause lithium metal to precipitate on the negative electrode plate, which may result in a deterioration or reduction in long life. Referring to FIG. 9, the positive electrode mixture pattern 142 having the grooves 126′ formed in the positive electrode mixture layer is formed on the inner surface of the positive electrode substrate, and thus, the reduction rate of the opposing area of the positive electrode plate becomes relatively greater than that of the opposing area of the negative electrode plate in the unit cell, thereby increasing the N/P ratio.

In some embodiments, in a case where the positive plate is formed on the inner side and the opposing negative plate is formed on the outer side, the N/P ratio of the curved portion 120a may be locally larger than the design. Referring to FIG. 9, the negative electrode mixture pattern 140 having the grooves 126′ formed in the negative electrode mixture layer is formed on the inner surface of the negative electrode substrate, and thus, the reduction rate of the opposing area of the negative electrode plate becomes relatively greater than that of the opposing area of the positive electrode plate in the unit cell, thereby decreasing the N/P ratio.

As a result, the phenomenon of lithium metal precipitation on the negative electrode during long-life may be alleviated and deterioration may be reduced or improved. In addition, because the grooves 126′ are formed in the mixture layer 122 of the curved portion 120a in this manner, the mixture density may be locally lowered, thereby alleviating stress generated due to the swelling phenomenon of the electrode plate during charging and discharging. Accordingly, deformation of the cell may be suppressed or reduced even during a long life.

In some embodiments, the mixture pattern may be formed selectively or may be formed both on the inner surface of the electrode substrate 124 and/or on the outer surface of the electrode substrate 124 so as to balance the N/P ratio.

In some embodiments, the imbalance problem in which the N/P ratio deviates from the design value may be greater in the first electrode plate and the second electrode plate on the innermost surface where the deviation in the radius of curvature between the opposing inner and outer electrode plates is the largest. Accordingly, in a case where the grooves 126′ are formed on the inner surface of the first mixture layer 124a′ or the second mixture layer 124b′ on the innermost surface, the degree of stabilization of the N/P ratio may be the greatest.

In some embodiments, in a case where the mixture layers 122 are arranged on opposite sides of the substrate 124 of the electrode plate, the mixture layer 122 on the inner side may have a greater change in curvature than the mixture layer 122 on the outer side, and thus, greater stress may be generated. In order to solve this problem, the mixture pattern including the grooves 126′ may be formed in the first mixture layer 124a′ or the second mixture layer 124b′ arranged on the inner surface of the first electrode plate 136 or the second electrode plate 138. The mixture pattern according to one or more embodiments of the present disclosure may be formed (e.g., selectively formed) only at positions where stress is concentrated or increased or where side reactions such as lithium metal precipitation are concentrated or increased.

FIG. 10 illustrates the process of processing the pattern on the curved portion of an electrode plate before winding.

As illustrated in FIG. 10, the position of the curved portion 120a with relatively high stress may be changed depending on the size of the cell. Therefore, based on the width of the cell, the curved portion 120a and the flat portion 120b may be set or specified in the electrode plate before winding. A pattern area may be formed on an electrode plate through a processing device 154 by designating a set or specific curved portion 120a as a processing site 152. The processing device 154 may be a laser, punching, or etching device and may be a device configured to form a plurality of grooves or holes. The electrode plate before winding may be transported horizontally through a roller 156, and the pattern area may be formed through the processing device 154 installed at the processing site 152 of the electrode plate along the transport direction.

FIG. 11 illustrates a flowchart showing a method for manufacturing an electrode assembly according to one or more embodiments.

Determining a processing site according to a width of a cell may be performed (S1). Forming a pattern area at the determined processing site by using a processing device may be performed (S2). In the case of a substrate pattern, applying a mixture to one side and/or the other side (e.g., opposite side) of the substrate may be performed after the substrate pattern is formed (S3). Performing rolling with a rolling device may be performed to flatten the mixture layer while fixing the mixture to the substrate pattern. (S4)

In some embodiments, in the case of a mixture pattern, forming of the the mixture pattern (S2) may be performed after applying of the mixture (S3). Performing of the rolling may be performed (S4) after the mixture pattern is formed, or performing of the rolling may be performed (S4) immediately before the mixture pattern is formed.

In addition, the substrate pattern processing and the mixture pattern processing may be performed simultaneously. As an example, in the case of an electrode plate in which the substrate pattern including the grooves and the mixture pattern including the grooves are formed together, the effect of controlling the local mixture density in the curved portion may be enhanced or improved.

The mixture applied to the electrode substrate may include (e.g., may be composed of) an active material, a binder, and a conductive material.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The material of the positive electrode substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

100: secondary battery
110: electrode assembly
120a: curved portion
120b: flat portion
122: mixture layer
124: substrate
124a: first substrate
124b: mixture substrate
124a′: first mixture layer
124b′: second mixture layer
126: groove
126′: groove
130: electrode tab
134: separator
136: first electrode plate
138: second electrode plate
140: negative mixture pattern
142: positive mixture pattern
144: hole
146: negative electrode substrate pattern
148: positive electrode substrate pattern
150: battery case
152: processing site
154: processing device
156: roller
S1: determining processing site
S2: forming pattern
S3: applying electrode mixture
S4: performing rolling

What is claimed is:

1. An electrode assembly comprising:
a first electrode plate comprising a first substrate comprising a first mixture layer thereon;
a second electrode plate comprising a second substrate comprising a second mixture layer thereon; and
a separator between the first electrode plate and the second electrode plate,
wherein the first electrode plate, the separator, and the second electrode plate are wound together to comprise a flat portion and a curved portion, and
a pattern area is on the curved portion of the first electrode plate or on the curved portion of the second electrode plate.

2. The electrode assembly as claimed in claim 1, wherein the pattern area comprises a substrate pattern in the first substrate or the second substrate.

3. The electrode assembly as claimed in claim 2, wherein the substrate pattern comprises grooves.

4. The electrode assembly as claimed in claim 3, wherein the grooves have a stripe shape.

5. The electrode assembly as claimed in claim 4, wherein an extension direction of the groove having the stripe shape is perpendicular to a longitudinal direction of the first electrode plate or the second electrode plate.

6. The electrode assembly as claimed in claim 3, wherein the grooves are on an inner surface of the first substrate or on an inner surface of the second substrate.

7. The electrode assembly as claimed in claim 2, wherein the substrate pattern comprises holes.

8. The electrode assembly as claimed in claim 7, wherein each of the holes has a diameter of several tens of micrometers.

9. The electrode assembly as claimed in claim 7, wherein the holes are located in columns.

10. The electrode assembly as claimed in claim 7, wherein the holes are formed by punching or etching.

11. The electrode assembly as claimed in claim 7, wherein a mixture included in the first mixture layer or in the second mixture layer passes through the first substrate or the second substrate through the holes.

12. The electrode assembly as claimed in claim 1, wherein the pattern area comprises a mixture pattern in the first mixture layer or in the second mixture layer.

13. The electrode assembly as claimed in claim 12, wherein the mixture pattern is in the first mixture layer on an inner surface of the first substrate or is in the second mixture layer on an inner surface of the second substrate.

14. The electrode assembly as claimed in claim 13, wherein the mixture pattern is in a mixture layer on an inner surface of an electrode plate located at an innermost surface of the electrode assembly.

15. The electrode assembly as claimed in claim 12, wherein the mixture pattern comprises grooves.

16. The electrode assembly as claimed in claim 15, wherein the grooves are formed by a laser.

17. The electrode assembly as claimed in claim 15, wherein the grooves have a stripe shape.

18. The electrode assembly as claimed in claim 17, wherein an extension direction of the groove having the stripe shape is perpendicular to a longitudinal direction of the first electrode plate or the second electrode plate.

19. A method for manufacturing an electrode assembly, the method comprising:
determining a processing site to be a curved portion in an electrode substrate;
forming holes or grooves at the processing site to be the curved portion in the electrode substrate;
applying an electrode mixture to the electrode substrate in which the holes or grooves are formed; and
rolling the electrode substrate to which the electrode mixture is applied.

20. A method for manufacturing an electrode assembly, the method comprising:
determining a processing site to be a curved portion in an electrode substrate;
applying an electrode mixture to the electrode substrate;
forming grooves in an electrode mixture portion corresponding to the processing site to be the curved portion in the electrode substrate; and
rolling the electrode substrate to which the electrode mixture is applied.
